(19) United States
(12) Patent Application Publication
(10) Pub. No.: US 2005/0147099 A1
(43) Pub. Date: Jul. 7, 2005

(54) Data transmission apparatus, systems, and methods

(75) Inventors: Praveen K. Subrahmanian, Bangalore (IN); Suryakant Maharana, Bangalore (IN); Vijay Chougule, Bangalore (IN)

Correspondence Address: SCHWEGMAN, LUNDBERG, WOESSNER & KLUTH, P.A., P.O. BOX 2938, MINNEAPOLIS, MN, 55402-0938, US

(73) Assignee: Intel Corporation

(21) Appl. No.: 10/740,955

(22) Filed: Dec. 17, 2003

(51) Int. Cl. H04L 12/56

(52) U.S. Cl. 370/394

(57) ABSTRACT

An apparatus and a system, as well as a method and article, may operate to immediately terminate fetching a packet from memory after determining that transmission of the packet has been aborted.

### TECHNICAL FIELD

Various embodiments described herein relate to data processing generally, such as apparatus, systems, and methods used to transmit and receive information, including data packets.

### BACKGROUND INFORMATION

Half-duplex Ethernet may use the CSMA/CD (Carrier Sense Multiple Access/Collision Detect) protocol to share a communications medium coupling multiple stations. Typically, a sending station waits for a time during which the medium is idle (e.g., when no other station is transmitting) to broadcast one or more frames of data. Other stations connected to the medium can then receive the information, unless one of the non-sending stations tries to send other data at the same time. When such a “collision” occurs, a jam sequence is sent to all receiving stations by the original sending station to notify them of the failure to send. The original sending station then remains silent for a random time period before attempting to transmit again; this is known as the “backoff” process. The sequence is repeated until the frame is successfully transmitted or a decision is taken to abort the packet due to multiple backoff's. For more information regarding the Ethernet standard, please see the Institute of Electrical and Electronics Engineers (IEEE) 802.3, 2000 Edition, IEEE Standard for Information Technology-Telecommunications and information exchange between systems—local and metropolitan area networks—specific requirements—Part 3: Carrier Sense Multiple Access with Collision Detection Access Method and Physical Layer Specifications.

The process of abort and transmitting the next packet may include fetching the data remaining in a packet whose transmission has already been aborted because of the occurrence of a collision. Retrieving such data may increase the inter-packet gap time on the transmission medium. Thus, apparatus, systems, and methods to more efficiently transmit data, including packets, are needed.

### BRIEF DESCRIPTION OF THE DRAWINGS

FIG. 1 is a block diagram of an apparatus and a system according to various embodiments;

FIG. 2 is a flow chart illustrating several methods according to various embodiments; and

FIG. 3 is a block diagram of an article according to various embodiments.

### DETAILED DESCRIPTION

In switches supporting half-duplex mode communication, packets may be dropped when collisions occur. For shared media, including those conforming to the Ethernet standard, efficiency may be improved by immediately turning to the next packet to be transmitted after aborting the current packet. This is especially true when the packet involved in a collision is large, and there is no need to fetch the remaining parts of the packet from memory to send all the way through a transmission data path.

Various embodiments to be described herein make use of a technique to immediately cease fetching the remaining portions of a packet from memory after it is determined that transmission of the packet has been aborted (e.g., the packet is associated with multiple collisions). To implement the technique, a sequence number may be allocated to each packet while the packet is read out from memory for transmission. The sequence number may be allocated on a per-port basis, and it can be incremented from packet to packet. The maximum value of the sequence number may depend on the maximum number of packets per-port that occupy the entire transmission data path. A set of sequence numbers may be allocated so as to wrap around to zero after reaching a selected maximum value.

If multiple collisions occur and transmission of the packet is aborted, a media access control (MAC) device, such as those conforming to the Ethernet standard and implementing the media access control layer as a hardware interface between the logical link control layer and the network medium that is in use (e.g., Ethernet, token ring, etc.), can alert memory manager logic with the abort status, perhaps accompanied by the sequence number of the packet having an aborted transmission. If a packet with that same sequence number is still being fetched from memory, the memory manager can immediately terminate fetching the remaining data for that packet, and begin fetching a portion of the next packet for transmission. This abort status can be used by any other module in the transmission path to quickly flush out the remaining portion of the aborted packet from the transmission path.

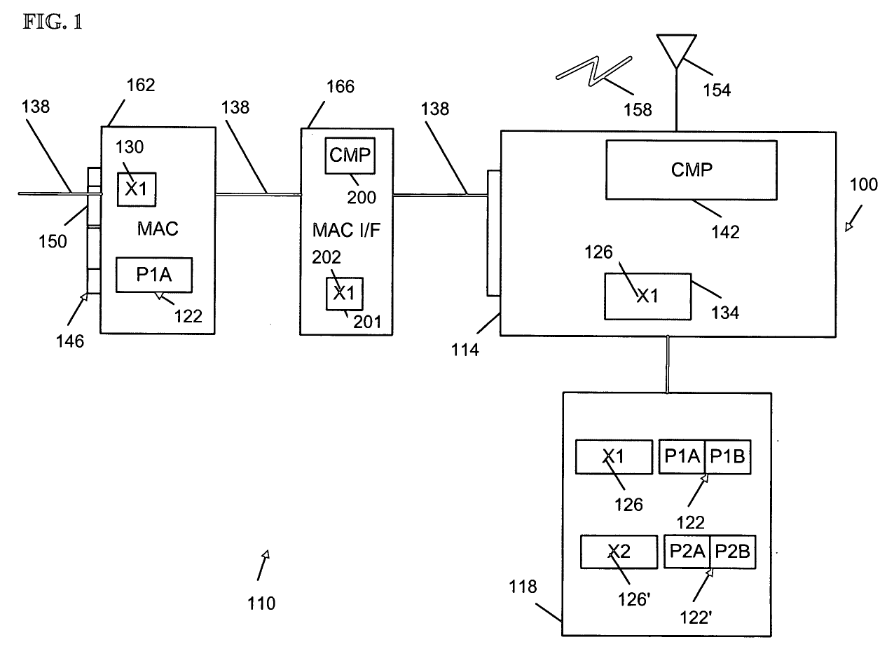

FIG. 1 is a block diagram of an apparatus 100 and a system 110 according to various embodiments, each of which may operate in the manner described above. For example, an apparatus 100 may comprise a control module 114 and a memory 118. The control module 114 may comprise memory manager logic and may be used to terminate fetching of a packet 122 from the memory 118 after determining that an assigned sequence number 126 matches a sequence number 130 associated with the packet 122. The apparatus 100 may also include a register 134 to store the assigned sequence number 126. The maximum value of the assigned sequence number 126 may be determined by a latency time associated with a communications medium 138 through which the packet 122 is to be transmitted. For example, a maximum value of sixteen may be used if it is determined that up to sixteen packets, similar to or identical to packet 122 may coexist in the medium 138 at one time.

The apparatus 100 may also include a comparison module 142 to compare the assigned sequence number 126 and the sequence number 130 associated with the packet 122. Thus, if a portion P1A of a first packet P1 is being transmitted in the medium 138, and a collision occurs, the transmission may be aborted, and the control module 114 may be notified of the abort status. Thus, if it is determined that the sequence number X1 assigned to packet P1 (associated with the portion P1A having an aborted transmission) matches the sequence number X1 assigned to packet P1 (associated with the portion of the packet still being fetched from the memory 118, e.g., P1B), then the control module 114 may immediately terminate fetching the remainder of the packet P1, that is, portion P1B, from the memory 118. The control module 114 may then operate to begin fetching packet 122′ (including portions P2A and P2B) from the memory 118 for transmission over the medium 138. Sequence number 126′ may be assigned to packet P2 at this time.

In another embodiment, a system 110 may comprise an apparatus 100 as described above, as well as a connector 146 including a port 150 to transmit the packet 122. The system 110 may also include an antenna 154, such as a monopole, dipole, patch, or omnidirectional antenna to receive information 158 included in the packet 122. In some embodiments, the system 110 may be included as part of an Ethernet card, or as part of a packet data switch.

The system 110 may include a MAC module 162 to couple to the control module 114 to terminate fetching of the packet 122. The system 110 may also include a MAC interface 166 to couple to the MAC module, as well as a communication medium 138 to couple to the connector 146 and to receive one or more portions of a packet, e.g., packet portion P1A. The MAC interface 166 may also include a comparator module 200 and sequence number 201 similar to or identical to those in memory controller 114. Thus, if it is determined that the sequence number X1 assigned to packet P1 (associated with the portion P1A having an aborted transmission) matches the sequence number X1 assigned to packet P1 (associated with the portion of the packet currently present in MAC interface 166), then the MAC interface 166 may immediately flush the portion of the packet P1 from its storage, if desired.

The apparatus 100, system 110, control module 114, memory 118, packets 122, 122′ sequence numbers 126, 126′, 130,202, registers 134, 201, communications medium 138, comparison modules 142, 200, connector 146, port 150, antenna 154, information 158, MAC module 162, and MAC interface 166 may all be characterized as “modules” herein. Such modules may include hardware circuitry, and/or one or more processors and/or memory circuits, software program modules, including objects and collections of objects, and/or firmware, and combinations thereof, as desired by the architect of the apparatus 100 and the system 110, and as appropriate for particular implementations of various embodiments.

It should also be understood that the apparatus and systems of various embodiments can be used in applications other than for communications ports, and other than for systems that include data switches, and thus, various embodiments are not to be so limited. The illustrations of an apparatus 100 and a system 110 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, data switches, and application-specific modules, including multilayer, multi-chip modules. Such apparatus and systems may further be included as sub-components within a variety of electronic systems, such as televisions, cellular telephones, personal computers, workstations, radios, video players, vehicles, and others.

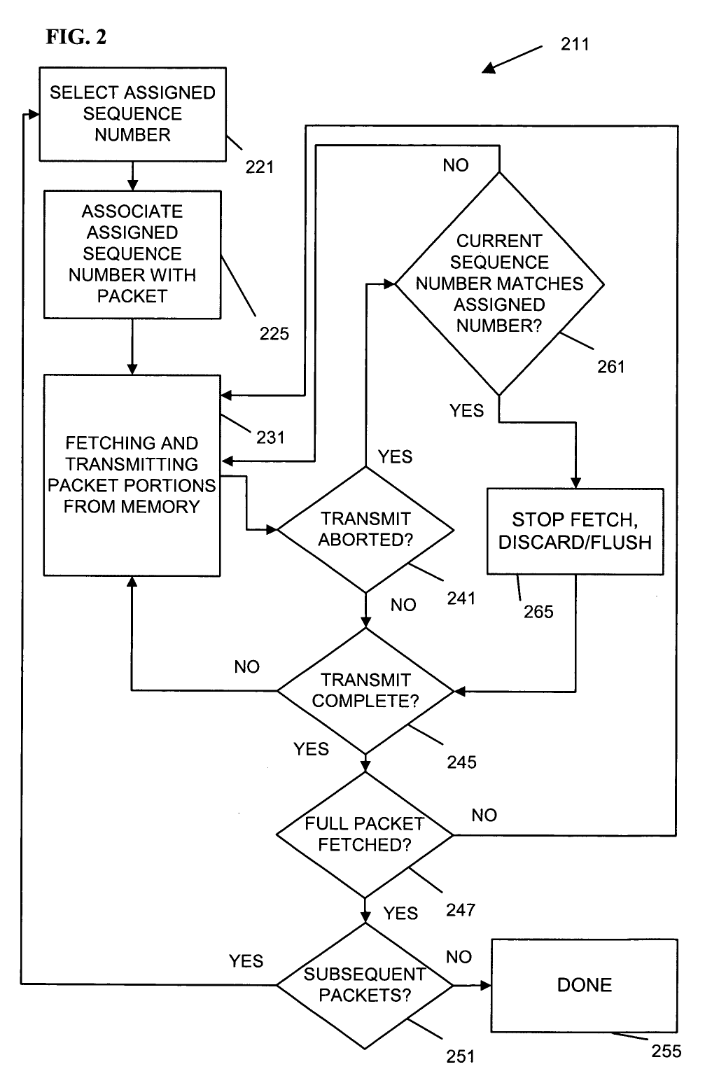

FIG. 2 is a flow chart illustrating several methods according to various embodiments. A method 211 may (optionally) begin with selecting a sequence number to be assigned to a packet, perhaps from a finite set of integers (e.g., 0, 1, 2, . . . 15) at block 221. The sequence number may be associated with or assigned to a packet that is to be transmitted, or it may be assigned to the packet at substantially the same time as the packet is being fetched from memory for transmission at block 225. Subsequent sequence numbers may be associated with or assigned to other packets, including those that are subsequently transmitted. For example, an assigned sequence number may comprise an integer X, and a subsequent sequence number may comprise an integer selected from zero and an integer greater than X (e.g., X+1). It is therefore possible to have a rotating set of sequence numbers for packets emanating from a single port, such as 0, 1, 2, 3, 0, 1, 2, 3, 0, . . . etc.

After a portion of one packet (e.g., P1A in FIG. 1) having an assigned sequence number (e.g., 10) is fetched from memory, the portion may be transmitted at block 231. If storage in the transmission path allows more data to be stored, subsequent portions of the same packet or other packets, including the next packet, may be fetched from the memory, and transmitted at block 231. Fetching and transmitting of portions of packets may occur in a serial fashion, such that a portion is fetched and then transmitted. Fetching and transmitting may also occur in a parallel fashion, such that packet portions may be fetched from memory and transmitted in a substantially simultaneous fashion.

When it is determined that the fetching of the packet P1 is complete at block 247, subsequent packets may be fetched for transmission. Thus, if it is determined that subsequent packets exist at block 251, then a subsequent sequence number (e.g., 11) may be selected at block 221 and assigned to another packet (e.g., P2) at block 225. Packet P2 may then be fetched from memory in portions as long as sufficient storage exists.

During the transmission of portions of the packets P1 or P2, it is possible that a collision may occur. If so, then transmission of the packet associated with the collision may be aborted. For example, if it is determined at block 241 that transmission of packet P1 has been aborted at some point during the transmission process, a check can be made to determine whether the sequence number assigned to packet P1 (e.g., 10) matches the sequence number of the packet currently being fetched from memory (which may be packet P1 if the abort occurs early in the transmission process, or possibly packet P2, if only the remainder of packet P1 was being transmitted when the collision occurred). Thus, the method 211 may include determining that a packet (e.g., P1) is being fetched from the memory, and determining the sequence number associated with that packet.

If the sequence numbers do not match at block 261 (e.g., if the sequence number 10 assigned to packet P1, having the aborted transmission, does not match the sequence number 11 assigned to packet P2, which is currently being fetched from memory), then the packet being fetched from memory will continue to be fetched from memory at block 231. However, if the sequence numbers do match at block 261 (e.g., if the sequence number 10 assigned to a portion of the packet P1, having the aborted transmission, does match the sequence number 10 assigned to a portion of the packet P1 which is currently being fetched from memory), then the method 211 may include immediately terminating fetching any remaining portion of the packet P1 (e.g., P1B) from memory at block 265 and discarding or flushing the portions that have already been fetched. That is, immediate termination of fetching a packet from memory may occur after determining that transmission of the packet has been aborted and that an assigned sequence number associated with the packet having the aborted transmission matches a sequence number associated with the packet currently being fetched from memory. Thus, the method 211 may also include fetching a first portion of a packet from a memory, and refraining from transmitting some remaining portion of the packet.

Many variations of the illustrated embodiments are possible. For example, a method may comprise sending a portion of a first packet having an assigned sequence number to a MAC module to transmit within a communications medium, determining that transmission of the portion of the first packet has been aborted, comparing the assigned sequence number of the first packet with a sequence number assigned to a second packet being fetched from a memory, and, if the assigned sequence number of the first packet matches the sequence number assigned to the second packet, immediately terminating fetching of the first packet from the memory. As noted previously, prior to termination, the assigned sequence numbers of the first and second packets may be selected from a finite set of integers.

Other activities may include sending a portion of the second packet to the MAC module to transmit within the communications medium, and transmitting the portion of the second packet within the communications medium. As noted above, the first packet and the second packet may be included in a frame, such that the second packet is located subsequent in time to the first packet within the frame.

It should be noted that the methods described herein do not have to be executed in the order described, or in any particular order. Moreover, various activities described with respect to the methods identified herein can be executed in serial or parallel fashion. For the purposes of this document, the terms “information” and “data” may be used interchangeably. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java, Smalltalk, or C++. Alternatively, the programs can be structured in a procedure-orientated format using a procedural language, such as assembly or C. The software components may communicate using any of a number of mechanisms well-known to those skilled in the art, such as application program interfaces or interprocess communication techniques, including remote procedure calls. The teachings of various embodiments are not limited to any particular programming language or environment, including Hypertext Markup Language (HTML) and Extensible Markup Language (XML).

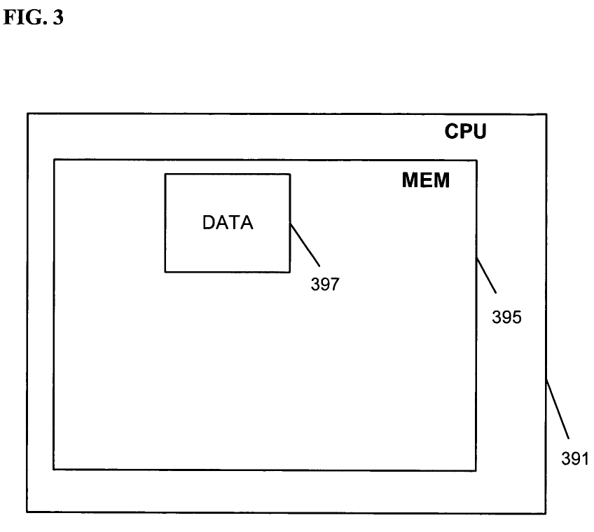

Thus, other embodiments may be realized. For example, FIG. 3 is a block diagram of an article 391 according to various embodiments, such as a computer, a memory system, a magnetic or optical disk, some other storage device, and/or any type of electronic device or system. The article 391 may comprise a machine-accessible medium such as a memory 395 (e.g., a memory including an electrical, optical, or electromagnetic conductor) having associated data 397 (e.g., computer program instructions), which when accessed, results in a machine performing such actions as immediately terminating fetching a first packet from a memory (and flushing or discarding any fetched portions of the first packet) after determining that transmission of the first packet has been aborted, and determining that an assigned sequence number matches a sequence number associated with the first packet. Other activities may include associating a subsequent sequence number with a second packet, as well as transmitting the second packet, wherein the assigned sequence numbers may comprise integers.

Many embodiments provide a wide variety of assigned sequence numbers. For example, the first packet may be assigned a sequence number comprising the integer X, and a subsequent sequence number assigned to a second packet may comprise an integer selected from zero and an integer greater than X (e.g., X+1). The maximum value of the assigned sequence numbers may be determined by a maximum number of packets in the selected communication medium. As noted above, the assigned sequence number may be associated with a plurality of packets transmitted from a single port.

Implementing the apparatus, systems, and methods described herein may result in reducing packet-to-packet gaps in the selected medium after collisions occur. This result may in turn provide improved line bandwidth utilization. For shared memory central queuing architectures, memory use may be reduced, and transmit data path bandwidth increased via increased port throughput.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method, comprising:
terminating fetching of a first packet from a memory after determining that transmission of the first packet has been aborted.

2. The method of claim 1, further comprising:
determining that an assigned sequence number matches a sequence number associated with the first packet.

3. The method of claim 1, further comprising:
associating a subsequent sequence number with a second packet; and
transmitting the second packet.

4. The method of claim 2, wherein the first packet and the second packet are included in a frame, and wherein the second packet is located subsequent in time to the first packet within the frame.

5. The method of 1, further comprising:
prior to terminating, fetching a portion of the first packet from the memory; and
transmitting the portion of the first packet.

6. The method of claim 1, further comprising:
selecting a series of sequence numbers including the assigned sequence number from a finite set of integers.

7. The method of claim 1, further comprising:
determining that the first packet is being fetched from the memory.

8. The method of claim 1, further comprising:
prior to terminating, fetching a first portion of the first packet from the memory; and
refraining from transmitting a remaining portion of the first packet.

9. The method of claim 1, further comprising:
flushing of a fetched portion of the first packet from the memory after determining that transmission of the first packet has been aborted.

10. A method, comprising:
sending a portion of a first packet having an assigned sequence number to a media access control module to transmit within a communications medium;
determining that transmission of the portion of the first packet within the communications medium has been aborted;
comparing the assigned sequence number of the first packet with a sequence number assigned to a second packet being fetched from a memory; and
if the assigned sequence number of the first packet matches the sequence number assigned to the second packet, terminating fetching of the first packet from the memory.

11. The method of claim 10, further comprising:
sending a portion of the second packet to the media access control module to transmit within the communications medium; and
transmitting the portion of the second packet within the communications medium.

12. The method of claim 10, wherein the first packet and the second packet are included in a frame, and wherein the second packet is located subsequent in time to the first packet within the frame.

13. The method of claim 10, further comprising:
selecting the assigned sequence number of the first packet and the sequence number assigned to the second packet from a finite set of integers.

14. The method of claim 10, further comprising:
flushing of a fetched portion of the first packet from a transmission path including the communications medium.

15. An article comprising a machine-accessible medium having associated data, wherein the data, when accessed, results in a machine performing:
terminating fetching of a first packet from a memory after determining that transmission of the first packet has been aborted.

16. The article of claim 15, wherein the data, when accessed, results in the machine performing:
associating a subsequent sequence number with a second packet; and
transmitting the second packet.

17. The article of claim 15, wherein the data, when accessed, results in the machine performing:
determining that an assigned sequence number matches a sequence number associated with the first packet.

18. The article of claim 17, wherein the assigned sequence number comprises an integer X, and wherein the subsequent sequence number comprises an integer selected from zero and an integer greater than X.

19. The article of claim 17, wherein a maximum value of the assigned sequence number is determined by a maximum number of packets in a communication medium.

20. The article of claim 17, wherein the assigned sequence number is associated with a plurality of packets transmitted from a single port.

21. The article of claim 17, wherein the data, when accessed, results in the machine performing:
prior to terminating, associating the assigned sequence number with the first packet; and
transmitting the first packet.

22. An apparatus, comprising:
a control module to terminate fetching of a packet from a memory after determining that an assigned sequence number matches a sequence number associated with the packet.

23. The apparatus of claim 22, further comprising:
a register to store the assigned sequence number.

24. The apparatus of claim 22, wherein a maximum value of the assigned sequence number is determined by a communication medium latency time.

25. The apparatus of claim 22, further comprising:
the memory to store at least a portion of the packet.

26. The apparatus of claim 22, further comprising:
a comparison module to compare the assigned sequence number and the sequence number associated with the packet.

27. A system, comprising:
a control module to terminate fetching of a packet from a memory after determining that an assigned sequence number matches a sequence number associated with the packet; and
a connector including a port to transmit the packet.

28. The system of claim 27, further comprising:
an omnidirectional antenna to receive information included in the packet.

29. The system of claim 27, further comprising:
a media access control module to couple to the control module to terminate fetching of the packet.

30. The system of claim 29, further comprising:
a media access control interface to couple to the media access control module.

31. The system of claim 22, further comprising:
a communication medium to couple to the connector and to receive a portion of the packet.
